(19) United States
(12) Patent Application Publication
(10) Pub. No.: US 2009/0256774 A1
(43) Pub. Date: Oct. 15, 2009

(54) Outdoor antenna box

(75) Inventors: Yu Lung Fang, Hsinchu (TW); Anson Cheng, Hsinchu (TW); Ching Liang Lee, Hsinchu (TW)

Correspondence Address: BACON & THOMAS, PLLC, 625 SLATERS LANE, FOURTH FLOOR, ALEXANDRIA, VA, 22314-1176, US

(73) Assignee: JStream Technologies, Inc., Hsinchu (TW)

(21) Appl. No.: 12/314,632

(22) Filed: Dec. 15, 2008

(30) Foreign Application Priority Data
Apr. 15, 2008 (TW) 97206388

(51) Int. Cl. H01Q 1/42

(52) U.S. Cl. 343/872

(57) ABSTRACT

The present invention provides an outdoor antenna box comprising a thermally conductive baseboard; a thermally conductive reflector in planar contact with the thermally conductive baseboard and has a first side face and a second side face; an antenna board securely mounted on the first side face of the thermally conductive reflector; a circuit board having a thermal body where the heat energy generated by the thermal body is transferred to the second side face of the thermally conductive reflector via a thermally conductive element; and a casing having an opening covered by the thermally conductive baseboard and an accommodation space that houses the thermally conductive reflector, the antenna board and the circuit board.

### BACKGROUND OF THE INVENTION

1. Field of the Invention

The present invention relates to an outdoor antenna box, and more particularly, to an outdoor antenna box having a thermally conductive reflector.

2. Description of Related Art

Wireless communication devices rely on antenna to communicate with the outside world, and the design of the antenna is gradually shifted from external to embedded style. In recent years, the wireless communication device is equipped with more and more functions, that is, it is no longer a device simply for making/receiving calls but a device capable of providing high bandwidth audio/video entertainment while featuring high performance, low radiation, compact size and stylish design.

Currently, wireless communication devices that require antenna include base station and subscriber station, stationary, nomadic or mobile, such as notebook computer, handset, mobile TV and satellite navigation system. These devices rely on good antenna design to optimize their performance. As each wireless communication system needs a corresponding antenna to receive and transmit signals, a wireless communication device is usually built with a plurality of antenna.

A conventional outdoor antenna box typically comprises a baseboard, an antenna board, a reflector, a circuit board and a casing. The casing houses the antenna board, the reflector and the circuit board and connects to the baseboard. The circuit board is arranged with a thermal body disposed between the circuit board and an inner side face of the casing. To effectively dissipate the heat energy generated by the thermal body, a part of the casing is usually made of metallic material with thermal pad in the inner side face of the metallic material in alignment with the thermal body such that the heat energy of the thermal body is conducted to the metallic material of the casing and then to the outside atmosphere.

While a part of the casing of the outdoor antenna box described above is made of plastic material only, the rest of it is made of metallic and plastic material. A casing made of both metallic and plastic materials tends to have higher production cost, hence having room for improvement.

### SUMMARY OF THE INVENTION

To address the drawback of the prior art where the casing of the antenna box is made of metallic and plastic materials that add to the production cost, the present invention provides an outdoor antenna box with a casing solely made of plastic material to effectively reduce the production cost.

The object of the present invention is to provide an outdoor antenna box which utilizes the thermal conductivity characteristics of a reflector board material to firstly transfer the heat energy generated by a thermal body of a circuit board to the thermally conductive reflector board through a thermally conductive element, then to a thermally conductive baseboard, and finally to the outside atmosphere to effectively cool the thermal body of the circuit board. As such, the heat energy generated by the thermal body of the circuit board can be dissipated to the outside atmosphere through the thermally conductive element, the thermally conductive reflector board, and the thermally conductive baseboard without requiring a part of the casing being made of metallic material to facilitate heat conduction. A casing made entirely of plastic material in one piece can lower the production cost.

To achieve the aforesaid objects, the outdoor antenna box according to the present invention comprises a thermally conductive baseboard; a thermally conductive reflector in planar contact with the thermally conductive baseboard and has a first side face and a second side face; an antenna board securely mounted on the first side face of the thermally conductive reflector; a circuit board having a thermal body, where the heat energy generated by the thermal body is transferred to the second side face of the thermally conductive reflector via a thermally conductive element; and a casing having an opening covered by the thermally conductive baseboard and an accommodation space that houses the thermal reflector, the antenna board and the circuit board.

Preferably, the thermally conductive baseboard is made of aluminum.

Preferably, the thermally conductive reflector is made of aluminum.

Preferably, the casing is made of plastic material.

Preferably, the thermally conductive element is at least a thermally conductive pipe.

Preferably, the invention further comprises a plurality of thermally conductive blocks respectively adhered to the thermal body of the circuit board and the second side face of the thermally conductive reflector, and the thermally conductive element is connected to the plurality of thermally conductive blocks.

Preferably, the thermal body is situated on the surface of the circuit board opposing the second side face of the thermally conductive reflector.

Preferably, the thermal body is an integrated circuit.

Preferably, the thermally conductive reflector has four side walls outwardly and vertically extending from the periphery, wherein one of the side walls is in planar contact with the thermally conductive baseboard.

Preferably, the thermally conductive element is a cooling chip.

Preferably, the cooling chip has a cool surface adhered to the thermal body of the circuit board and a hot surface adhered to the second side face of the thermally conductive reflector.

### BRIEF DESCRIPTION OF THE DRAWINGS

FIG. 1 is an exploded view of the outdoor antenna box according to the present invention.

FIG. 2 is a side view showing the thermally conductive element and the thermally conductive block respectively connected to the thermal body of the circuit board and the second side face of the thermally conductive reflector.

FIG. 3 is a side view showing the thermally conductive element connected to the thermal body of the circuit board and the second side face of the thermally conductive reflector respectively.

### DETAILED DESCRIPTION OF THE INVENTION

The present invention will be fully described with preferred embodiments and accompanying drawings. It should be understood beforehand that any person familiar with the skill is able to make modification to the invention described and attain the same effect, and that the description below is a general representation to people familiar with the skill and should not be construed as a limitation on the actual applicable scope of the present invention.

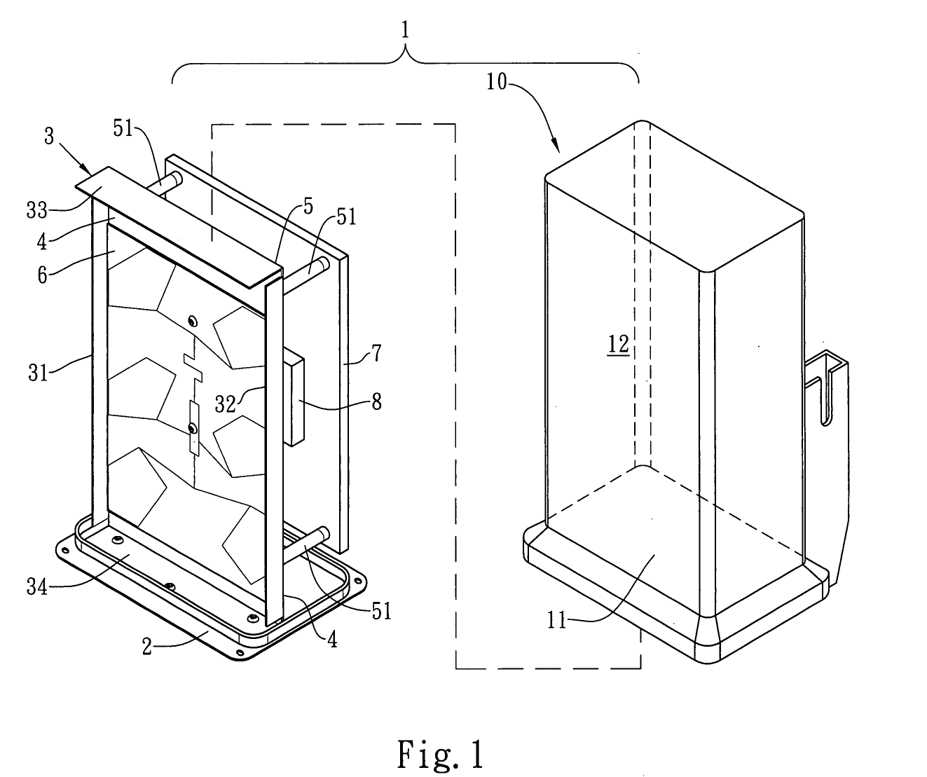

Referring to FIG. 1 which is an exploded view of the outdoor antenna box according to the present invention, the outdoor antenna box 1 comprises a thermally conductive baseboard 2; a thermally conductive reflector 3 having a first side face 4, a second side face 5, and four side walls 31, 32, 33, 34 extending outwardly and vertically from the periphery, among which the side wall 34 is in planar contact with the thermally conductive baseboard 2; an antenna board 6 securely mounted on the first side face 4 of the thermally conductive reflector 3; a circuit board 7 having a thermal body 8 where heat energy generated by the thermal body 8 is transferred to the second side face 5 of the thermally conductive reflector 3 via a thermally conductive element 9, and the circuit board 7 is connected to the thermally conductive reflector 3 via a plurality of connectors 51; and a casing 10 having an opening 11 and an accommodation space 12. When the casing 10 and the thermally conductive baseboard 2 are assembled together, the opening 11 of the casing 10 is covered by the thermally conductive baseboard 2 while the accommodation space 12 of the casing 10 houses the thermally conductive reflector 3, the antenna board 6 and the circuit board 7.

Both the thermally conductive baseboard 2 and the thermally conductive reflector 3 are made of aluminum while the casing 10 is made of plastic material.

The thermal body 8 is situated on the surface of the circuit board 7 opposing the second side face 5 of the thermally conductive reflector 3. The thermal body 8 is an integrated circuit.

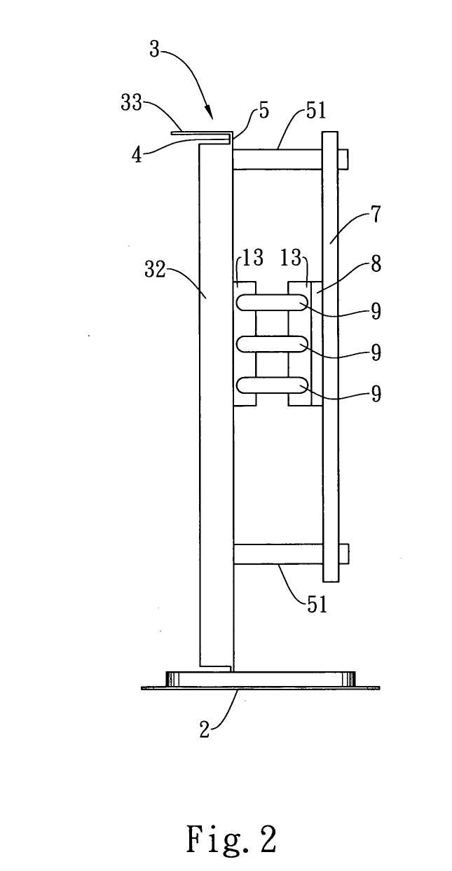

FIG. 2 is a side view showing the thermally conductive element 9 and a plurality of thermally conductive blocks 13 respectively connected to the thermal body 8 of the circuit board 7 and the second side face 5 of the thermally conductive reflector 3. In this embodiment, the thermally conductive element 9 is implemented as a thermally conductive pipe. The outdoor antenna box 1 of the present invention further comprises two thermally conductive blocks 13 respectively adhered to the thermal body 8 of the circuit board 7 and the second side face 5 of the thermally conductive reflector 3, and the thermally conductive element 9 is connected to the two thermally conductive blocks 13. The thermally conductive element 9 and the thermally conductive blocks 13 are mainly configured to transfer the heat energy generated by the thermal body 8 of the circuit board 7 to the thermally conductive reflector 3.

When the thermal body 8 of the circuit board 7 operates and generates heat energy, the heat energy of the thermal body 8 is firstly conducted to the thermally conductive reflector 3 through the thermally conductive element 9 and the thermally conductive blocks 13, then to the thermally conductive baseboard 2, and finally to the outside atmosphere to effectively cool the thermal body 8 of the circuit board 7.

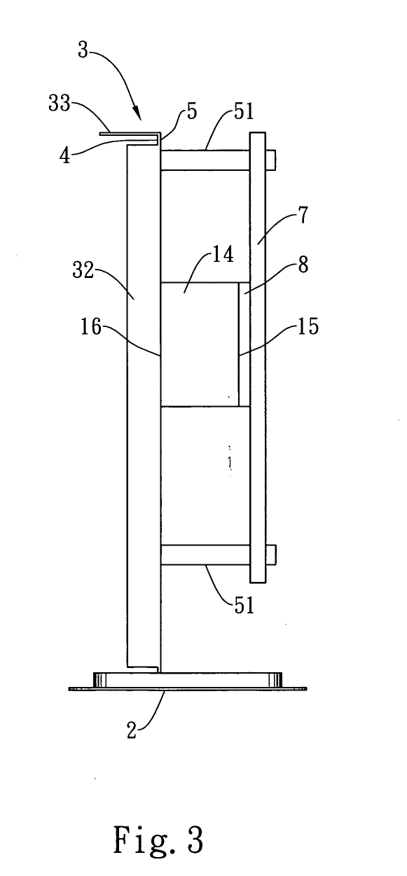

FIG. 3 is a side view showing a thermally conductive element 14 connected to the thermal body 8 of the circuit board 7 and the second side face 5 of the thermally conductive reflector 3 respectively. In this embodiment, the thermally conductive element 14 is implemented as a cooling chip. The thermally conductive element 14 has a cool surface 15 adhered to the thermal body 8 of the circuit board 7 and a hot surface 16 adhered to the second side face 5 of the thermally conductive reflector 3. The thermally conductive element 14 is mainly configured to transfer the heat energy generated by the thermal body 8 of the circuit board 7 to the thermally conductive reflector 3.

When the thermal body 8 of the circuit board 7 operates and generates heat energy, the heat energy of the thermal body 8 is firstly conducted to the thermally conductive reflector 3 through the thermally conductive element 14, then to the thermally conductive baseboard 2, and finally to the outside atmosphere to effectively cool the thermal body 8 of the circuit board 7.

As the thermally conductive reflector is situated between the circuit board and the antenna board, the heat energy generated by the thermal body of the circuit board is firstly transferred to the thermally conductive reflector via the thermally conductive element, then to the thermally conductive baseboard, and finally to the outside atmosphere. Therefore, the main advantage of the outdoor antenna box of the present invention is that it can effectively cool the thermal body of the circuit board. In addition, the casing of the antenna box can be fabricated in one piece using plastic material to lower the production cost.

The preferred embodiments of the present invention have been disclosed in the examples. However the examples should not be construed as a limitation on the actual applicable scope of the invention, and as such, all modifications and alterations without departing from the spirits of the invention remain within the protected scope and claims of the invention.

What is claimed is:

1. An outdoor antenna box, comprising:
a thermally conductive baseboard;
a thermally conductive reflector in planar contact with said thermally conductive baseboard and has a first side face and a second side face;
an antenna board securely mounted on said first side face of said thermally conductive reflector;
a circuit board having a thermal body, where the heat energy generated by said thermal body is transferred to said second side face of said thermally conductive reflector through a thermally conductive element; and
a casing having an opening covered by said thermally conductive baseboard and an accommodation space that houses said thermally conductive reflector, said antenna board and said circuit board.

2. The outdoor antenna box according to claim 1, wherein said thermally conductive baseboard is made of aluminum.

3. The outdoor antenna box according to claim 1, wherein said thermally conductive reflector is made of aluminum.

4. The outdoor antenna box according to claim 1, wherein said casing is made of plastic material.

5. The outdoor antenna box according to claim 1, wherein said thermally conductive element is at least a thermally conductive pipe.

6. The outdoor antenna box according to claim 5, further comprising a plurality of thermally conductive blocks respectively adhered to said thermal body of said circuit board and said second side face of said thermally conductive reflector, and wherein said thermally conductive element is connected to said plurality of thermally conductive blocks.

7. The outdoor antenna box according to claim 1, wherein said thermal body is situated on the surface of said circuit board opposing said second side face of said thermally conductive reflector.

8. The outdoor antenna box according to claim 1, wherein said thermal body is an integrated circuit.

9. The outdoor antenna box according to claim 1, wherein said thermally conductive reflector has four side walls extending outwardly and vertically from the periphery, among which one of said side walls is in planar contact with said thermally conductive baseboard.

10. The outdoor antenna box according to claim 1, wherein said thermally conductive element is a cooling chip.

11. The outdoor antenna box according to claim 10, wherein said cooling chip has a cool surface adhered to said thermal body of said circuit board and a hot surface adhered to said second side face of said thermally conductive reflector.
